(19) United States
(12) Patent Application Publication
(10) Pub. No.: US 2026/0141668 A1
(43) Pub. Date: May 21, 2026

(54) APPARATUS AND METHOD FOR IMAGE SEGMENTATION BASED ON LEARNABLE TOKENS

(71) Applicant: RESEARCH & BUSINESS FOUNDATION SUNGKYUNKWAN UNIVERSITY, Suwon-si (KR)

(72) Inventors: Sung Eun HONG, Seoul (KR); Jae Ik KIM, Yongin-si (KR); Yoon Jae BAEK, Seoul (KR); Ae Cheon JUNG, Anyang-si (KR)

(21) Appl. No.: 19/379,343

(22) Filed: Nov. 4, 2025

(30) Foreign Application Priority Data
Nov. 21, 2024 (KR) 10-2024-0166817

(51) Int. Cl. G06V 10/26; G06V 10/82

(52) U.S. Cl. CPC G06V 10/26; G06V 10/82

(57) ABSTRACT

The present disclosure relates to image segmentation apparatus and method based on learnable tokens. The image segmentation apparatus may comprise a first fusion processor configured to obtain a patch embedding corresponding to a segmentation target image, obtain a learnable token related to a target in the segmentation target image, and perform encoding using an encoder based on the patch embedding and the learnable token, and a second fusion processor configured to obtain information on the patch embedding, obtain information on the learnable token, and perform decoding based on the information on the learnable token and the patch embedding.

### CROSS-REFERENCE TO RELATED APPLICATION

This application claims the priority benefit of Korean Patent Application No. 10-2024-0166817 filed on Nov. 21, 2024 in the Korean Intellectual Property Office, the disclosure of which is incorporated herein by reference.

### BACKGROUND

### 1. Field

The present invention relates to an image segmentation apparatus and an image segmentation method.

### 2. Description of the Related Art

Image segmentation allocates each pixel in an image to a specific class, and has become an essential technology in various fields that require search, inference, or determination based on an image, such as autonomous driving, medical image analysis, robot vision, or augmented reality. The image segmentation-based technology aims to accurately identify a meaningful object or region in a complex scene by individually recognizing and classifying each element in an image. For example, in autonomous driving, an image captured by a vehicle or the like is divided into pixels to recognize and analyze pedestrians or vehicles on a road, and in medical image analysis, each tissue or lesion may be detected and classified through segmentation of a medical image.

Conventionally, a Convolutional Neural Network (CNN)-based learning model has been mainly used for image segmentation. The convolutional neural network showed excellent performance in extracting and analyzing regional features in images, but there was a limit to integrating the global context of images because it generally focuses on local information in images.

In order to effectively integrate global information of images, Vision Transformer (ViT)-based models are being introduced to image segmentation. The vision transformer model is an application of the transformer architecture used in the natural language processing field to image analysis, and is provided to divide a given image into patch units, tokenize it, and input it into the transformer in the form of a sequence. According to the vision transformer, global information of the entire image is efficiently integrated based on an encoder and a decoder, and prediction is performed by understanding a wide range of contexts, thereby enabling more accurate image segmentation by capturing the context of a specific object or background element.

However, the known vision transformer models have excellent global information processing performance, but relatively lack regional detailed information processing performance in an image. In particular, in the image segmentation operation, it is necessary to actively utilize local information in the image in order to recognize the exact shape or boundary of an object. For example, in autonomous driving, accurate recognition of boundaries such as vehicles, pedestrians, or road signs is directly related to safety, so precise processing of local information is very important. However, in the vision transformer-based image segmentation method known in the art, since the focus is on global information processing, detailed information may be lost, and thus it may be difficult to clearly distinguish a small object or a complex boundary. In addition, many of the proposed models mainly depend on a method of fusing local information in the decoder stage, which often omits detailed elements in the image due to an excessive delay in the timing of processing the local information.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The present disclosure aims to provide an image segmentation apparatus and an image segmentation method capable of effectively reflecting local information within an image to improve the accuracy and precision of image segmentation.

The image segmentation apparatus may comprise a first fusion processor configured to obtain a patch embedding corresponding to a segmentation target image, obtain a learnable token related to a target in the segmentation target image, and perform encoding using an encoder based on the patch embedding and the learnable token, and a second fusion processor configured to obtain information on the patch embedding, obtain information on the learnable token, and perform decoding based on the information on the learnable token and the patch embedding.

The first fusion processor may remove a learnable token from a sequence embedding output from the encoder, and perform decoding using a decoder based on the sequence embedding from which the learnable token has been removed, wherein the decoder includes at least one of a vision transformer-based decoder and a convolutional neural network-based decoder.

The information on the patch embedding may comprise query embedding for the patch embedding obtained by the first fusion processor.

The second fusion processor may perform patch-token cross-attention processing based on query embedding for the patch embedding, key embedding obtained from the learnable token, and value embedding obtained from the learnable token, and token-patch cross-attention processing based on key embedding and value embedding for the patch embedding obtained by performing the patch-token cross-attention processing and query embedding obtained from the learnable token.

The second fusion processor may combine a result sequence by the patch-token cross-attention processing and a result sequence by the token-patch cross-attention processing, input a result of combining the result sequence to a convolutional neural network, and perform an upsampling processing on an output of the convolutional neural network.

An image segmentation method may comprise obtaining a patch embedding corresponding to an segmentation target image, obtaining a learnable token related to a target in the segmentation target image, performing encoding using an encoder based on the patch embedding and the learnable token and obtaining information on the patch embedding, obtaining information on the learnable token, and performing decoding based on information on the learnable token and the patch embedding.

The image segmentation method further comprises removing a learnable token from a sequence embedding output from the encoder and performing decoding using a decoder based on the sequence embedding from which the learnable token is removed, wherein the decoder includes at least one of a vision transformer-based decoder and a convolutional neural network-based decoder.

The obtaining information on the patch embedding, obtaining information on the learnable token, and performing decoding based on the patch embedding and information on the learnable token may comprise at least one of performing patch-token cross-attention processing based on query embedding for the patch embedding obtained by the encoder, key embedding obtained from the learnable token, and value embedding obtained from the learnable token and performing token-patch cross-attention processing based on key embedding and value embedding for the patch embedding obtained by performing the patch-token cross-attention processing and query embedding obtained from the learnable token.

The obtaining information on the patch embedding, obtaining information on the learnable token, and performing decoding based on the patch embedding and information on the learnable token further comprises combining a result sequence by the patch-token cross-attention processing and a result sequence by the token-patch cross-attention processing, inputs a result of combining the result sequence to a convolutional neural network, and performs an upsampling processing on an output of the convolutional neural network.

To solve the above-described problem, an image segmentation apparatus and an image segmentation method are provided.

According to the above-described image segmentation apparatus and image segmentation method, it is possible to further improve the accuracy and precision in image segmentation by effectively reflecting regional information in the image.

According to the above-described image segmentation apparatus and image segmentation method, it is possible to obtain an advantage in that the boundary of the object is clearly distinguished even in a complex image, and important detailed elements are reflected so that the image may be segmented.

According to the above-described image segmentation apparatus and image segmentation method, by effectively capturing local information in an initial processing process based on a learnable token and learning the ability to capture local information in a post-processing process, it is possible to accurately process boundaries and details of objects in an image, and to correct performance consistency even in various environments and data sets.

According to the above-described image segmentation apparatus and image segmentation method, the complexity of the model for image segmentation is not greatly increased, and the image processing cost required by the PMD (Path Mixing Decoder) is reduced, and thus, the image segmentation apparatus and the image segmentation method can be easily applied to and integrated into various models without additional data or structural changes, thereby obtaining advantages of high usability and practicality.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of an image segmentation apparatus according to an embodiment.

FIG. 2 is a block diagram of a processor according to an embodiment.

FIGS. 3A and 3B are diagrams illustrating an example of a transformer layer for a learnable token.

FIGS. 4A, 4B, 4C, and 4D are diagrams illustrating an example of a proposal for a segmented region according to an embodiment.

FIGS. 5A, 5B, 5C, and 5D are diagrams illustrating an example of an attention map in a process of a processor according to an embodiment.

FIG. 6 is a diagram illustrating an example of an average attention distance according to an embodiment.

FIG. 7 is a diagram comparing the performance of the image segmentation apparatus according to an embodiment with the related art.

FIG. 8 is a diagram of an image segmentation apparatus according to an embodiment and an mIoU (Mean Intersection over Union) of each of the prior art.

FIG. 9 is a diagram illustrating a comparison between an image segmentation apparatus according to an embodiment and the related art in relation to RGB, RGB-D, and depth-only modality.

FIG. 10 is a diagram illustrating performance of each of an embodiment using a vision transformer-based decoder and an embodiment using a convolutional neural network-based decoder.

FIGS. 11A, 11B, 11C, and 11D are graph diagrams illustrating an example of sensitivity of a hyperparameter.

FIG. 12 is a flowchart of an image segmentation method according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, and methods for achieving them, will become apparent from the embodiments described below with reference to the accompanying drawings. However, the present invention is not limited to the embodiments disclosed herein and may be implemented in various other forms. The embodiments are provided merely to ensure that the disclosure of the present invention is complete and to fully convey the scope of the invention to those skilled in the art. The scope of the present invention is defined only by the claims.

The terms used in the present specification will be briefly described, followed by a detailed description of the present invention. The terms used in the present invention have been selected, to the extent possible, from widely used general terms while taking into account the functions of the invention; however, they may vary depending on the intent of a person skilled in the art, judicial precedents, or the emergence of new technologies. In certain cases, terms arbitrarily selected by the applicant may also be used, and in such cases, the meanings thereof will be described in detail in the corresponding description of the invention. Accordingly, the terms used in the present invention should not be interpreted merely based on their names, but should be defined based on the meanings of the terms and the overall context of the present invention. When a certain part is described in the specification as being connected to another part, it may mean that the parts are physically connected to each other and/or electrically connected to each other. In addition, when a certain part is described as including another part, unless otherwise explicitly stated, it does not exclude the inclusion of additional parts other than the other part, and may further include other parts depending on the embodiment. The terms “part,” “module,” “unit,” and the like used in the specification refer to units corresponding to all or a portion of at least one device, system, method, structure, or material, and may process predetermined functions or operations depending on the context. The terms “part,” “module,” and “unit,” and the like may be implemented in software, in hardware such as an FPGA or ASIC, or as a combination of software and hardware, depending on the designer, administrator, or user. However, the terms “part,” “module,” and “unit” are not limited to software or hardware only. The “part,” “module,” and “unit” may be configured to reside on an addressable storage medium and may be configured to reproduce one or more processors. Accordingly, by way of example, the terms “part,” “module,” and “unit” may include components such as software components, object-oriented software components, class components, and task components, as well as processes, functions, attributes, procedures, subroutines, segments of program code, drivers, firmware, microcode, circuits, data, databases, data structures, tables, arrays, and variables. According to embodiments, one “unit,” “module,” or “part” may be implemented as a single physical or logical configuration, or may be implemented as multiple physical or logical configurations. In addition, it is also possible that a plurality of “units,” “modules,” or “parts” are implemented as a single physical or logical configuration. Expressions such as “first” to “N-th” (where N is a natural number of one or more) are used, for convenience of description, to distinguish at least one element from other elements, and may be arbitrarily selected and applied to the components. For example, a component referred to as a “first component” may also be referred to as a “second component,” and a component referred to as a “second component” may likewise be referred to as a “first component.” In addition, expressions such as “first” to “N-th” do not necessarily imply that the components are sequential unless specifically stated otherwise. The term “and/or” may include any combination of a plurality of associated items or any one of a plurality of associated items, but does not exclude the combination of two or more of the associated items. A singular expression may include a plural form unless it is clearly indicated otherwise by the context. Furthermore, an underscore (_) generally indicates that the character following the underscore represents a subscript of the character preceding it, and a caret (\hat{ }) generally indicates that the character following the caret represents a superscript of the character preceding it, although they may be used with different meanings depending on the context.

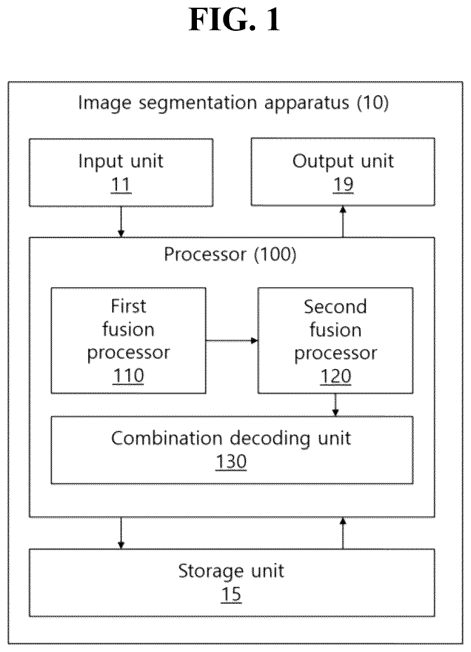

Hereinafter, an embodiment of an image segmentation apparatus will be described with reference to FIGS. 1 to 11D.

FIG. 1 is a block diagram of an image segmentation apparatus according to an embodiment.

Referring to FIG. 1, the image segmentation apparatus 10 may include an input unit 11, a storage unit 15, an output unit 19, and a processor 100. At least two of the input unit 11, the storage unit 15, the output unit 19, and the processor 100 are provided to transmit data, instructions (instructions), and/or programs (which may be referred to as apps, applications, or software) in the form of electrical signals, or in other forms. At least one of the input unit 11, the storage unit 15, and the output unit 19 may be omitted according to an embodiment.

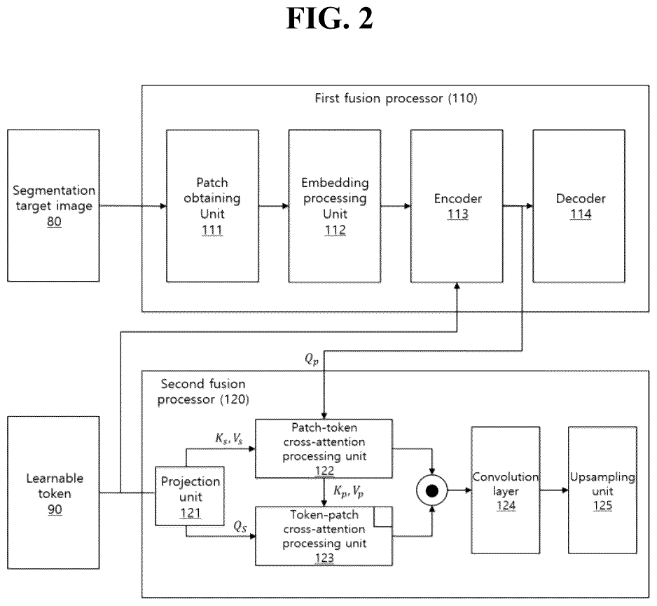

The input unit 11 may receive data or programs necessary for the operation of the image segmentation apparatus 10 from the outside. For example, the input unit 11 may receive one or more target images subject to segmentation (80 of FIG. 2, hereinafter, referred to as segmentation target image) from the outside. Data input through the input unit 11 may be transmitted to at least one of the storage unit 15 and the processor 100. The input unit 11 may include, for example, a keyboard, a mouse, a tablet, a touch screen, a touch pad, a scanner device, an image capturing module (camera device), an ultrasonic scanner, a light receiving sensor, a pressure reduction sensor, a proximity sensor, a microphone, a data input/output terminal (USB port, etc.), or a communication module (e.g., a LAN card, a short-range communication module, a mobile communication module, etc.).

The storage unit 15 may temporarily or non-temporarily store data or programs necessary for the operation of the image segmentation apparatus 10. For example, the storage 15 may store the one or more segmentation target images 80 transmitted from the input unit 11, may provide the one or more segmentation target images 80 stored according to a call of the processor 100 to the processor 100, may store data obtained in a processing process of the processor 100 or a learning model trained or completed by the processor 100, and/or may store a segmentation result obtained from the segmentation target image 80 based on the trained learning model. The storage unit 15 may store at least one program, and the at least one program may be directly written by a designer such as a programmer, or may be transmitted from another physical recording medium (an external memory device or a compact disk (CD)), or may be obtained through an electronic software distribution network. The storage unit 15 may be implemented using at least one of a register, a cache memory, a main memory device, and an auxiliary memory device according to an embodiment.

The output unit 19 may output and provide data obtained according to the operation of the image segmentation apparatus 10 to the outside. For example, the output unit 19 may output the segmentation result obtained from the segmentation target image 80 to the outside by using the trained learning model, and may provide the segmentation result visually or audibly to the user, or may transmit the segmentation result to another device communicatively connected. In addition, the output unit 19 may output a graphical user interface, stored data, all or part of a program, and/or a command to the outside. The output unit 19 may include, for example, a display, a printer device, a speaker device, an image output terminal, a data input/output terminal, or a communication module, but is not limited thereto.

The processor 100 may train a learning model for segmentation of the segmentation target image 80, and/or may obtain a segmentation result corresponding to the segmentation target image 80 by using the learning model that is being trained or trained. According to an embodiment, the processor 100 may perform only training of the learning model, or may perform only obtaining a segmentation result corresponding to the segmentation target images 80. The processor 100 may execute a program stored in the storage 15 to perform a predefined operation, determination, processing, and/or control operation, thereby performing training or obtaining a segmentation result. According to an embodiment, the processor 100 may be implemented by using a Central Processing Unit (CPU), a Graphic Processing Unit (GPU), a Micro Controller Unit (MCU), an Application Processor (AP), a Electronic Controlling Unit (ECU), a Micro Processor (Micom), and/or at least one electronic device capable of performing various operations and control processes alone or in combination.

The processor 100 uses an early fusion path, a late fusion path, and a PMD (Path Mixing Decoder) for effectively integrating the early fusion path and the late fusion path, wherein in the early fusion path, a learnable token integrates local information at the beginning of the encoder, and in the late fusion path, the corresponding token is processed to be used as a segmented region suggestion in the PMD (path mixing decoder), so that information (e.g., a patch) about a specific region in the image may be sufficiently and appropriately preserved and utilized in the overall process. According to an embodiment, since the processor 100 may integrate the region information in the initial fusion path, it is free to select a decoder. Accordingly, for example, the processor 100 may use at least one of a vision transformer-based decoder and a convolutional neural network-based decoder as the decoder.

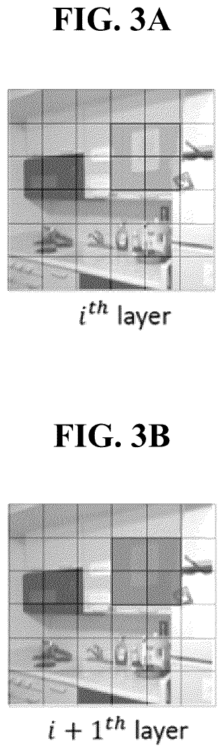

FIG. 2 is a block diagram of a processor according to an embodiment, and FIGS. 3A and 3B are diagrams illustrating an example of a transformer layer for a learnable token. FIG. 3A shows an i-th transformer layer, and FIG. 3B shows an (i+1)-th transformer layer.

According to an embodiment, as illustrated in FIGS. 1 and 2, the processor 100 may include a first fusion processor 110, a second fusion processor 120, and a combination decoding unit 130. At least two of the first fusion processor 110, the second fusion processor 120, and the combination decoding unit 130 may be physically divided or logically divided depending on the situation. When physically separated, at least two of them may be implemented using a processing device physically separated from each other. For example, the first fusion processor 110 and the second fusion processor 120 may be implemented by a graphic processing unit, and the combination decoding unit 130 may be implemented by a central processing unit. In addition, when logically divided, at least two of them may be implemented by one processing device, for example, a graphic processing device or a central processing device. If necessary, at least one of the first fusion processor 110, the second fusion processor 120, and the combination decoding unit 130 may be omitted.

As shown in FIG. 2, the first fusion processor 110 is provided to integrate the learnable token 90 containing the region information in the encoder 113 to capture detailed information of the image patch, and to enable the regional image analysis of the model. Specifically, the first fusion processor 110 receives the segmentation target image 80 and the learnable token 90 simultaneously or sequentially, and acquires a localized attention between patch embeddings for the segmentation target image 80, so that regional details are reflected. In this case, the first fusion processor 110 may obtain the query embedding vector Q_p for the image patch, output the query embedding vector Q_p, and provide the query embedding vector Q_p to the second fusion processor 120. According to an embodiment, the first fusion processor 110 may obtain a decoding result corresponding thereto based on the encoding result by the encoder 113.

According to an embodiment, the first fusion processor 110 may include a patch obtaining unit 111, an embedding processing unit 112, an encoder 113, and a decoder (Model Agnostic Decoder) 114.

The patch obtaining unit 111 may receive at least one segmentation target image 80 and obtain at least one image patch from the segmentation target image 80. The image patch may be obtained by segmenting the segmentation target image 80 into polygons (e.g., squares, etc.) of the same size and/or different sizes.

When at least one patch for the segmentation target image 80 is obtained, the embedding processor 112 may perform embedding on the obtained at least one patch for input to the encoder 113 to obtain at least one patch embedding corresponding to the at least one patch. The patch embedding is transmitted to the encoder 113 and input. According to an embodiment, position embedding may be added to each patch embedding.

The encoder 113 may receive the patch embedding and the learnable token 90, and may perform encoding by connecting the patch embedding and the learnable token 90. Here, according to an embodiment, the learnable token 90 may include regional information on at least one region in the image or an object of the corresponding region in advance or through training. When segmentation target image 80 is segmented into a plurality of patches by the patch obtaining unit 111, and when two or more adjacent patches include all or some of a specific object (e.g., a recipe card), if at least one of the corresponding adjacent patches is related to the learnable token 90, the learnable token 90 has a relationship with at least one patch adjacent to the patch as well as a patch directly related to the corresponding token 90 in a learning process (which may include at least one of a training process and an inference process). In other words, the learnable token 90 pays higher attention to patches around the patch as well as a specific patch having strong relevance than other patches. In the process of performing learning, the learnable token 90 is gradually more strongly connected to a plurality of specific patches, i.e., a patch having high relevance and a patch(s) adjacent thereto. For example, as shown in FIGS. 3A and 3B, the encoder 113 processes a token (e.g., a token having a relation with a paper attached to a wall) having some degree of relation with a specific region in any one layer (e.g., the i-th layer L_i (i is 0 or a natural number of 1 or more)) to have a stronger relation with the corresponding region in another layer (e.g., the (i+1)-th layer L_(i+1))). The process of strengthening the connectivity of the learnable token 90 to local information, for example, a specific object in the region, enables more accurate segmentation of boundaries or detailed information of a specific region (specific object) of an image. Accordingly, local information in the image is properly integrated in the learning process, so that the overall more precise image segmentation may be performed.

In more detail, if the learnable token 90 is a d-dimensional vector provided to be learnable and the set of learnable tokens is S, the set of learnable tokens S may be given as Equation 1 below.

$$S = \{ {s}_{k} ∈ \vert 1 \leq k \leq N , k ∈ ℕ \} \qquad [ Equation 1 ]$$

Here, N is the length of the learnable token S. The token 90 and the patch embedding that may be learned in the first layer L_1 of the input sequence for the encoder 113 may be concatenated. This may be expressed as Equation 2 below.

$${Z}_{1} = [ {E}_{1} , {G}_{1} ] = {L}_{1} ( {E}_{0} , S ) \qquad [ Equation 2 ]$$

Equation 2 represents a result of processing performed in the first layer (i=1) of the encoder 113 as an equation, and in Equation 2, E_1 is a set of first patch embeddings. The length of the patch embedding set may be, for example, M. G_1 denotes the feature of the learnable token 90 calculated by the first layer L_1, and Z_1 denotes sequence embedding in the output space of the first layer L_1. In addition, [⋅,⋅] is a concatenate according to the sequence length dimension. Subsequently, the encoder 113 may process the learnable token 90 according to Equation 3 below.

$${Z}_{i} = [ {E}_{i} , {G}_{i} ] = {L}_{i} ( [ {E}_{i - 1} , {G}_{i - 1} ] ) , i = 2 , 3 , … , ℓ \qquad [ Equation 3 ]$$

Equation 3 is an equation representing a concatenation process by the encoder 113. In Equation 3, E_i is a set of patch embeddings given as M in length and output by the i-th layer L_i, and is input to the next layer, that is, the (i+1)th layer L_(i+1). G_i denotes a characteristic of the learnable token 90 output by the i-th layer L_i, and Z_i denotes sequence embedding in the output space of the i-th layer L_i. I means the total number of layers of the encoder 113. Through this self-attention mechanism using the learnable token 90 as local information, the final patch embedding of the encoder may capture both local and global contexts of the image.

In addition, if the encoder 113 is a transformer or vision transformer-based encoder to be described later, the encoder 113 may output one or more query embedding vectors Q_p for the image patch as necessary. The query embedding vector Q_p for the image patch may be obtained during the learning process.

Meanwhile, the encoder 113 may remove the learnable tokens 90 and G_I from the finally output sequence embedding. The sequence embedding from which the learnable tokens 90 and G_I are removed may be transmitted to at least one of the decoder 114 and the second fusion processor 120.

According to an embodiment, the encoder 113 may include a transformer-based encoder, and for example, may include a vision transformer (ViT)-based encoder. In this case, the encoder 113 may include a multi-head self-attention and feed-forward network, and based on the patch embedding and the sequence embedding obtained by the connection of the learnable token 90, the plurality of layers L_i and i are 1, 2, 3, . . . . In this case, the encoder 113 may include a multi-head self-attention and feed-forward network, and based on the patch embedding and the sequence embedding obtained by the connection of the learnable token 90, the plurality of layers L_i and i are 1, 2, 3, . . . . Learning is performed through I). However, the encoder 113 is not limited to a transformer-based encoder, and according to an embodiment, a designer may implement the above-described encoder 113 using an encoder other than the corresponding encoder.

The decoder 114 may receive a sequence embedding from which the learnable tokens 90 and G_I are removed, and may perform decoding using the received sequence embedding. The decoder 114 may upsample the image embedding as an accurate pixel-by-pixel prediction result.

According to an embodiment, the decoder 114 may perform decoding by using only image embedding, and since the image embedding to be decoded already includes local information in the encoding process, decoding may be performed without separate local information. Accordingly, the decoder 114 may be implemented by using various decoders, and may be implemented by using any one of, for example, a vision transformer-based decoder and a convolutional neural network-based decoder. In other words, the decoder 114 may be a model independent decoder.

According to an embodiment, the decoder 114 receives the final sequence of the encoder 111 in which the learnable tokens 90 and G_I are absent, and maps the final sequence for prediction of the output value y∈R\hat{ }H×W×K. Here, H×W means the size of an image, and K means the number of classes. The output value may include a segmentation result of the segmentation target image 80.

In this case, the loss function L_Early of the first fusion processor 110 described above may be given as a sum of two loss functions L_mse and L_focal as shown in Equation 4 below.

$${L}_{Early} = {L}_{mse} + {γL}_{focal} \qquad [ Equation 4 ]$$

In Equation 4, L_mse denotes mean squared error loss, and L_focal denotes focal loss. The γ is a balance parameter and is provided to adjust the weight between the mean square error loss (L_mse) and the focal loss (L_focal). The balance parameter y may be defined by a user or a designer. Here, the mean square error loss L_mse may be given by Equation 5 below.

$${L}_{mse} = \frac{1}{K \times H \times W} {\sum }_{k = 1}^{K} {\sum }_{h = 1}^{H} {\sum }_{w = 1}^{W} {( {\hat{c}}_{khw} - {c}_{khw} )}^{2} \qquad [ Equation 5 ]$$

In Equation 5, \hat{ }c_khw denotes a predicted pixel value, and c_khw denotes an actual value (i.e., a correct answer). As described above, K, H, and W refer to the number of classes, the height of an image, and the width of an image.

The focal loss L_focal is to solve the class imbalance problem by focusing more on the esoteric misclassification case in semantic segmentation, and may be given, for example, by Equation 6 below.

$${L}_{focal} = - 0.25 {( 1 - {p}_{t} )}^{2} log ( {p}_{t} ) \qquad [ Equation 6 ]$$

In Equation 6, p_t is a class probability corresponding to the predicted pixel value (\hat{ }c_khw).

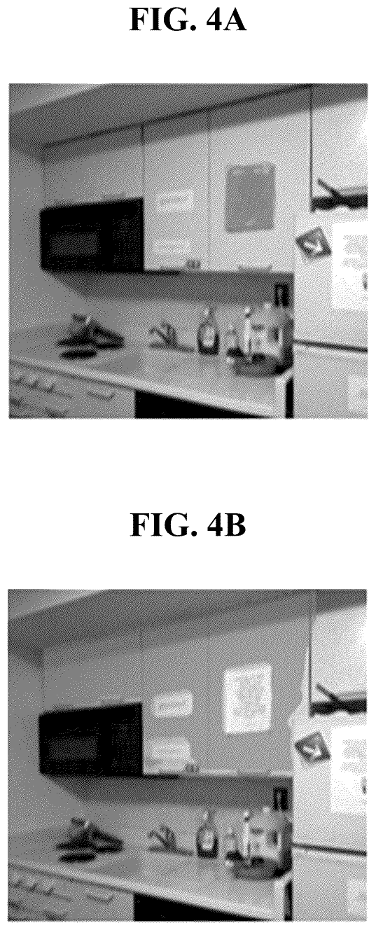

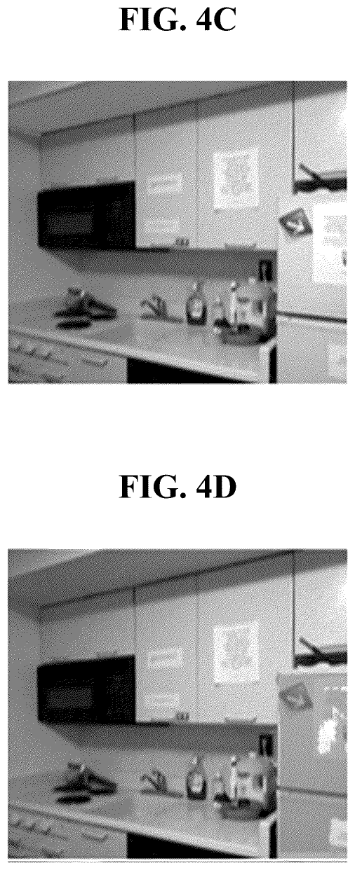

FIGS. 4A to 4D are views showing an example of a proposal for a segmented region according to an embodiment, and in FIGS. 4A to 4D, paper attached to a cabinet door, a cabinet door, a ceiling at the top of the cabinet door, and a refrigerator door next to a sink are emphasized in different colors from other parts. It represents the segmentation region proposal in which each of the color-emphasized parts is output.

According to an embodiment, the second fusion processor 120 allows the learnable token 90 to have a certain level of semantic segmentation or more while simultaneously embracing a local context. That is, the second fusion processor 120 controls the interaction between the final image embedding E_i from the encoder 113 and the learnable tokens 90 and S, so that the learnable token 90 processed by the first fusion processor 110 is not damaged by the global information of the patch embedding.

Specifically, the second fusion processor 120 may be provided to obtain, for example, information on patch embedding processed by the encoder 113, for example, a query embedding vector Q_p, obtain a learnable token 90 that interacts with patch embedding, and perform decoding based on the obtained information. When the learnable token 90 is trained to improve the accuracy of image segmentation, it may have a function of proposing a segmentation region as shown in FIGS. 4a to 4D. The proposed segmented region function is to propose a region in which an object (object) exists or is likely to exist, because the learnable token 90 may capture regional information about the object. The second fusion processor 120 enables the proposal for the segmented region to be performed using the token 90 that may be learned as described above. As described above, the first fusion processor 110 acquires and integrates the region information of the learnable token 90, and the second fusion processor 120 mixes the process of acquiring and integrating the region information of the learnable token 90 and the process of generating the proposal for the segmented region, and acquires the result, and thus, it may be referred to as, for example, a PMD (Path Mixing Decoder).

According to an embodiment, the second fusion processor 120 may include a projection unit 121, a patch-token cross-attention processing unit 122, a token-patch cross-attention processing unit 123, a convolution layer 124, and an upsampling unit 125.

The projection unit 121 may obtain a corresponding query Q_S, a key K_S, and a value V_S by using the learnable token 90, may transmit the query Q_S to the token-patch cross-attention processing unit 123, and may transmit the key K_S and the value V_S to the patch-token cross-attention processing unit 122.

The second fusion processor 120 may be implemented using bidirectional cross-attention, and enables the image patch region to detect relevant region information from the learnable token 90, and enables the learnable token 90 to collect necessary region information in a predetermined image patch region. Here, the learnable token 90 has a function of proposing a segmented region. In addition, learning of excessive global information in the first fusion processor 110 may be suppressed. According to an embodiment, to this end, the second fusion processor 120 may include a patch-token cross-attention processing unit 122 and a token-patch cross-attention processing unit 123.

The patch-token cross-attention processing unit 122 according to an embodiment may receive the key embedding vector K_s and the value embedding vector V_s for the learnable token 90 from the projection unit 121, receive the query embedding vector Q_p for the image patch from the first fusion processor 110, and calculate and obtain an attention based on the received key embedding vector K_s and the value embedding vector V_s. This may be expressed by Equation 7 below.

$$Attention ( {Q}_{p} , {K}_{s} , {V}_{s} ) = softmax ( \frac{{Q}_{p} {K}_{s}^{T}}{\sqrt{d}} ) {V}_{s} \qquad \{ Equation 7 ]$$

In Equation 7, Q_p is a query vector for an image patch, and K_s and V_s are key and value embeddings corresponding to the learnable token 90. Softmax( ) means the softmax function. d refers to the dimension of the query embedding vector Q_p for the image patch and the key embedding vector K_s for the learnable token 90, and may be prepared for scaling of the query embedding vector Q_p and the key embedding vector K_s.

According to an embodiment, the processing result of the patch-token cross-attention processing unit 122 may include a key embedding vector K_p for the image patch and a value embedding vector V_p for the image patch, and the token-patch cross-attention processing unit 123 may obtain other attentions using the key embedding vector K_p for the image patch and the value embedding vector V_p for the image patch to improve the performance of the image segmentation apparatus 10.

Meanwhile, the token-patch cross-attention processing unit 123 may receive the query embedding vector Q_s for the learnable token 90 from the projection unit 121, obtain the key embedding vector K_p for the image patch and the value embedding vector V_p for the image patch, and then obtain an attention based thereon. Here, the key embedding vector K_p for the image patch and the value embedding vector V_p for the image patch may be transmitted from the patch-token cross-attention processing unit 122. According to an embodiment, the key embedding vector K_p for the image patch and the value embedding vector V_p for the image patch may be transmitted from the encoder 113 of the first fusion processor 110. The operation of the token-patch cross-attention processing unit 123 may be given as in Equation 8 below.

$$Attention ( {Q}_{s} , {K}_{p} , {V}_{p} ) = softmax ( \frac{{Q}_{s} {K}_{p}^{T}}{\sqrt{d}} ) {V}_{p} \qquad [ Equation 8 ]$$

In Equation 8, Q_s is a query embedding vector corresponding to the learnable token 90, and K_p and V_p are a key embedding vector and a value embedding vector corresponding to the image patch.

In the bidirectional cross-attention, the patch-token cross-attention processing unit 122 may perform image embedding as a query so that the patch region may find related information from the token, and the token-patch cross-attention processing unit 123 may perform a query so that the learnable token 90 may selectively collect local information in a specific region of the patch. Accordingly, the learnable token 90 may focus on a specific region of the image.

According to an embodiment, the output of the patch-token cross-attention processing unit 122, that is, the result sequence, and the output of the token-patch cross-attention processing unit 123, that is, the result sequence, may be mutually combined and transmitted to the convolution layer 124. Here, the combination of the outputs of the patch-token cross-attention processing unit 122 and the token-patch cross-attention processing unit 123 may be performed, for example, through a point product operation.

The convolutional layer 124 is provided to generate a segmentation map by mapping N tokens 90 to K classes, and may include one or more layers according to embodiments. The convolutional layer 124 may be provided by using a result of combining the output of the patch-token cross-attention processing unit 122 and the output of the token-patch cross-attention processing unit 123 as an input value, and using a segmentation map corresponding to the segmentation target image 80 as an output value.

The upsampling unit 125 may adjust the resolution by upsampling the segmentation map, which is the output value of the convolutional layer 124. In this case, the upsampling unit 125 may upsample the segmentation map so that the segmentation map matches the resolution of the original image 80. In this case, the upsampling may include, for example, double linear upsampling, but is not limited thereto.

According to an embodiment, the above-described second fusion processor 120 may be implemented using a transformer decoder or a decoder that partially modifies the transformer decoder, and is provided to simply maintain the entire approach while maintaining and encapsulating local information in the learnable token 90.

According to an embodiment, the second fusion processor 120 may not be used in the inference process. In other words, when the segmentation target image 90 is segmented by using the image segmentation apparatus 10 after the learning is completed, the segmentation result corresponding to the image to be segmented 90 may be obtained only by the operation of the first fusion processor 110.

The loss function L_late of the second fusion processor 120 may be implemented based on the predicted segmentation map and the actual segmentation map, and may be provided using, for example, an average square error.

The total loss function L_total of the first fusion processor 110 and the second fusion processor 120 may be defined by Equation 9 below.

$${L}_{total} = {L}_{Early} + {λL}_{Late} \qquad [ Equation 9 ]$$

Here, A is a hyperparameter that may be set by a user or a designer for balancing between the loss function of the first fusion processor 110 and the loss function of the second fusion processor 120.

The total loss function L_total combines the losses generated in the first fusion processor 110 and the second fusion processor 120 to effectively embed local information in the learnable token 90, and enables the encoder 113 to optimize and utilize it.

Hereinafter, a reason why the image segmentation apparatus 10 described above operates effectively will be described. When a set of all image patches is defined as P, a set of image patches (image patch set) including all or a part of an object while being spatially adjacent to each other is defined as M and N, and two adjacent patches including all or a part of an object are defined as m and n, respectively, the two adjacent patches m and n are included in the image patch sets M and N (m∈M and n∈N), and the image patch sets M and N are included in the set of all image patches P while being spatially adjacent to each other (that is, M and N⊆P). Here, the image patch set M may be a patch set closely aligned with the learnable token 90(s). In addition, the learnable token 90(s) may be learned or learned to recognize a specific object. Then, the attention score between the token 90(s) and the image patches m and n that may be learned for all predetermined adjacent patches n∈N may be given as shown in Equation 10 below.

$${a}_{s , n} \approx {a}_{s , m} > {a}_{s , p} for all p ∈ P \text{\textbackslash (} M ⋃ N ) . \qquad [ Equation 10 ]$$

In Equation 10, α_s,m means an attention score between a token that can be learned and any adjacent patch (m) including a part of a subject, and α_s,n means an attention score between another adjacent patch (n) including a part of the subject and a token that can be learned(s) 90. α_s,p is an attention score for the remaining image patches that do not belong to the image patches M and N adjacent to the target. Since the learnable token 90(s) is strongly connected to any adjacent patch M, the attention scores α_s, n between the learnable token 90(s) and the other adjacent patch N are approximated to the attention scores α_s, m between the learnable token 90(s) and the other adjacent patch, and are greater than the attention scores α_s, p for patches that do not belong to other patches, i.e., the image patches m, m.

Since the key embedding vector k_s of the learnable token 90(s) is similar to any patch M representing a part of the subject, the attention scores α_N and S between the learnable token 90(s) and another patch N representing another part of the subject approximate the attention scores α_N and M between the two patches. Accordingly, the output vector y_N reflects information from any patch M, and may be given as in Equation 11 below.

$${y}_{N} = {α}_{N , S} \cdot {υ}_{S} + {\sum }_{I ∉ S} {α}_{N , l} \cdot {υ}_{l} \approx {α}_{N , M} \cdot {υ}_{M} + {\sum }_{I ∉ S} {α}_{N , l} \cdot {υ}_{l} \qquad [ Equation 11 ]$$

In Equation 11, v_M represents at least one value embedding vector belonging to any patch set M, and v_I represents a value embedding vector for a patch that does not correspond to the set S of learnable tokens. Through this, the other patch set N integrates local information from any patch set M based on the set S of learnable tokens, and as a result, the representation of the other patch set N becomes similar to the representation of any patch set M. Accordingly, the interaction between the patch sets M and N (which may correspond to two parts of the object) is refined by the self-attention, so that the object segmented by the patches m and n may be accurately segmented into one object (local attention).

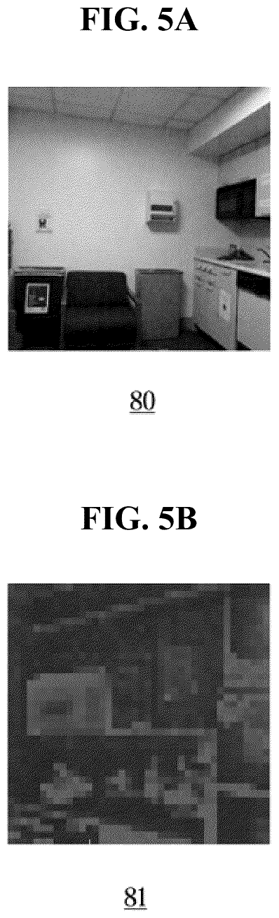

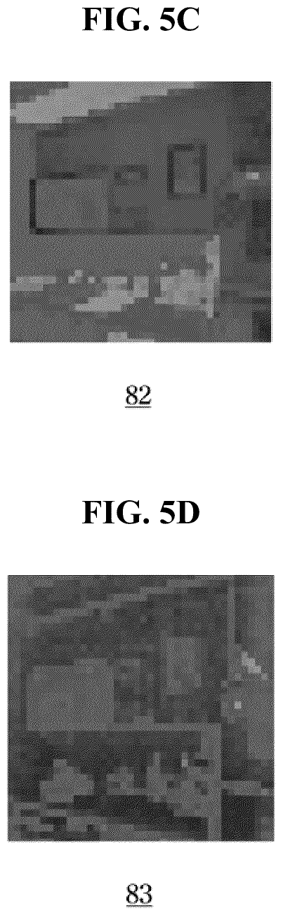

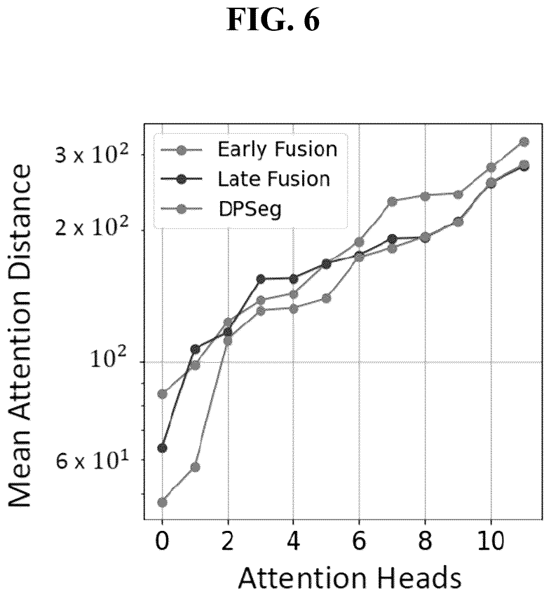

FIGS. 5A to 5D are diagrams illustrating an example of an attention map in a process of a processor according to an embodiment, and FIG. 6 is a diagram illustrating an example of an average attention distance according to an embodiment. In FIGS. 5A to 5D, 80, 81, 82, and 83 denote an input image, an attention map of a learnable token in the case of using only the first fusion processor, an attention map of a learnable token in the case of using only the second fusion processor, and an attention map in the case of fusing both the first fusion processor and the second fusion processor through the combination decoding unit 130. A relatively bright region in each attention map 81, 82, and 83 means a higher attention value. In addition, in FIG. 6, the x-axis represents the aligned attention heads, and the y-axis represents the mean attention distance. In the graph, Early Fusion represents the average attention distance according to the attention head in the case of using only the first fusion processor 110, Late Fusion represents the average attention distance according to the attention head in the case of using the second fusion processor 120, and DPSeg represents the average attention distance according to the attention head in the case of using both the first and second fusion processors.

Comparing the attention map 81 in the case of using only the first fusion processor 110, the attention map 82 in the case of using only the second fusion processor 120, and the attention map 83 in the case of using both the processors 110 and 120 and the combination decoding unit 130 for the same segmentation target image 80 with each other, as shown in FIGS. 5A to 5D, the attention map 83 in the case of using both the processors 110 and 120 rather than the attention maps 81 and 82 in the case of using only one fusion processor 110 and 120 corresponds to each detailed and specific region (for example, a specific object) in the image 80 region) is reflected more accurately and precisely. In addition, as shown in FIG. 6, the average attention distance is also smaller when both of the processors 110 and 120 are used than when only one fusion processor 110 and 120 is used. This means that the case where both 110 and 120 are used is more focused on regional information. In other words, it can be seen that the above-described image segmentation apparatus 10 may more accurately perform image segmentation by deriving an object from an image by sufficiently reflecting regional information.

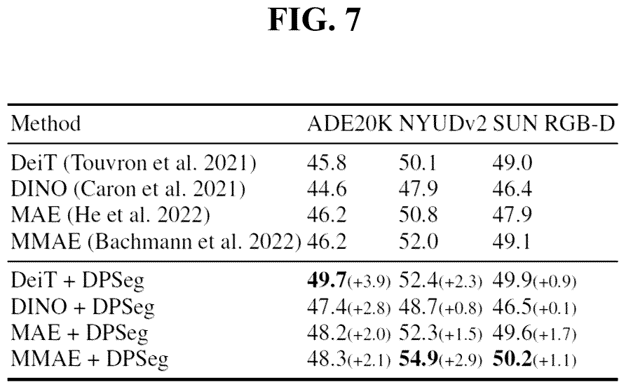

FIG. 7 is a diagram comparing the performance of the image segmentation apparatus according to an embodiment with the related art, and compares the performance of other models DeiT, DINO, MAE, and MMAE and the above-described image segmentation apparatus 10 and DPSeg in three benchmark datasets ADE20K, NYUDv2, and SUN RGB-D.

Referring to FIG. 7, it can be seen that the above-described image segmentation apparatuses 10 and DPSeg consistently outperform other models in terms of performance in all benchmark datasets. In addition, through this, it can be seen that the image segmentation apparatus 10 described above has flexibility and versatility that may be integrated with a conventional model without depending on the type of the model, and shows effective and excellent performance even when combined with these models (DeiT+DPSeg, DINO+DPSeg, MAE+DPSeg, MMAE+DPSeg).

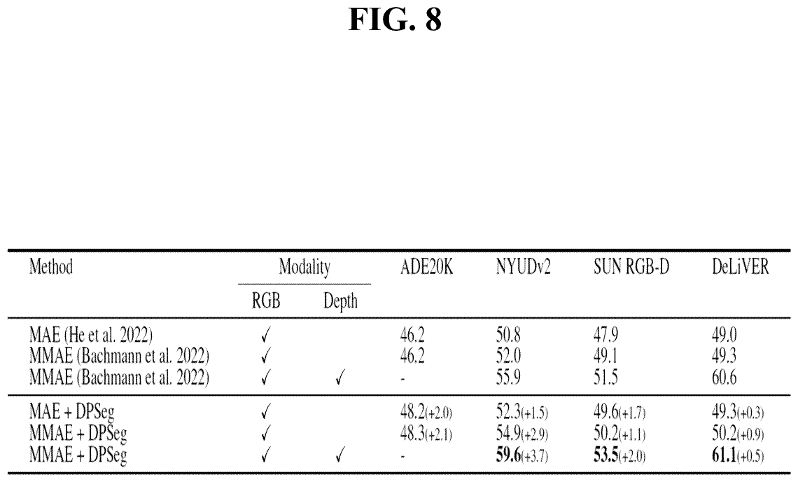

FIG. 8 is a diagram of an image segmentation apparatus according to an embodiment and an mIoU (Mean Intersection over Union) of each of the prior art. FIG. 8 shows a comparison of the performance of the conventional MAE and the above-described image segmentation apparatus 10 in four benchmark datasets ADE20K, NYUDv2, SUN RGB-D, and DeLIVER by adding depth modality.

Referring to FIG. 8, the image segmentation apparatus 10 described above has improved performance in both RGB and RGB-D settings, which is particularly noticeable in the MultiMAE backbone. Specifically, the mIoU of the image segmentation apparatus 10 described above is increased by about 3.6% compared to other models. This shows that the utilization of the first and second fusion processors 110 and 120 is effective, but in particular, it shows that it is more useful when transferring a pre-trained model to a new downstream task in a multimodal setting.

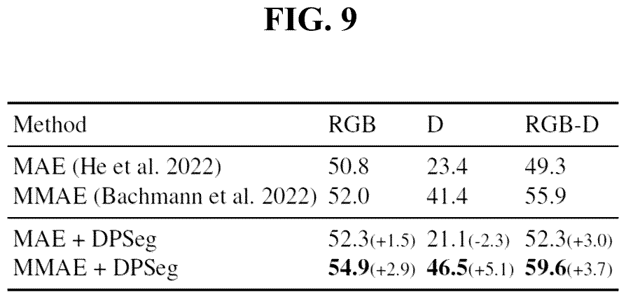

FIG. 9 is a diagram illustrating a comparison between an image segmentation apparatus according to an embodiment and the related art in relation to RGB, RGB-D, and depth-only modality.

As shown in FIG. 9, it can be seen that the effects of the image segmentation apparatus 10 described above for various modalities in the NYUDv2 dataset are consistent. In particular, the above-described image segmentation apparatus 10 improves the mIoU performance in both the RGB and RGB-D modalities, and the performance improvement is more prominent in the depth-only modality. This is because the image segmentation apparatus 10 may effectively capture meaningful local information, and consistently improve semantic segmentation performance for various types of inputs.

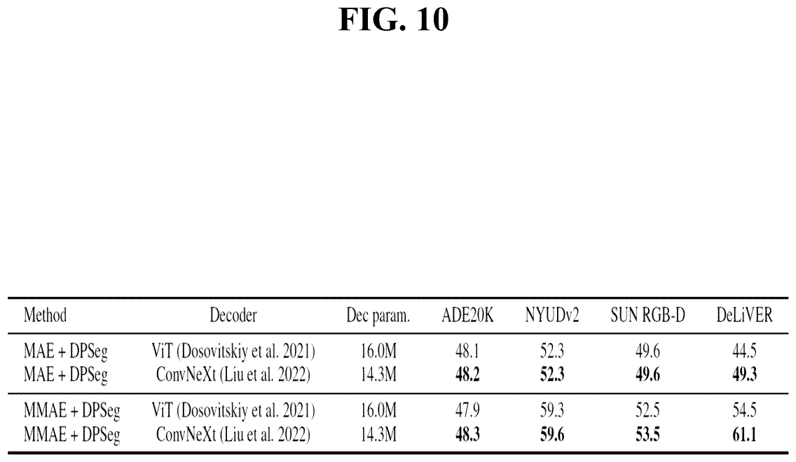

FIG. 10 is a diagram illustrating performance of each of an embodiment using a vision transformer-based decoder and an embodiment using a convolutional neural network-based decoder, and compares performance differences between the vision transformer-based decoder and the convolutional neural network-based decoder.

Referring to FIG. 10, the image segmentation apparatus 10 is compatible with various types of decoders, and shows that semantic segmentation performance may be improved by combining transformer-based downsampling and convolutional neural network-based upsampling. Specifically, integrating local information using the learnable token 90 is difficult to process because, in a convolutional neural network-based decoder, a feature may be damaged when converting a patch sequence back to an image format. However, the image segmentation apparatus 10 decodes the patch embedding that receives the local attention from the encoder 113, and thus may be compatible with both the vision transformer-based decoder and the convolutional neural network-based decoder as described above.

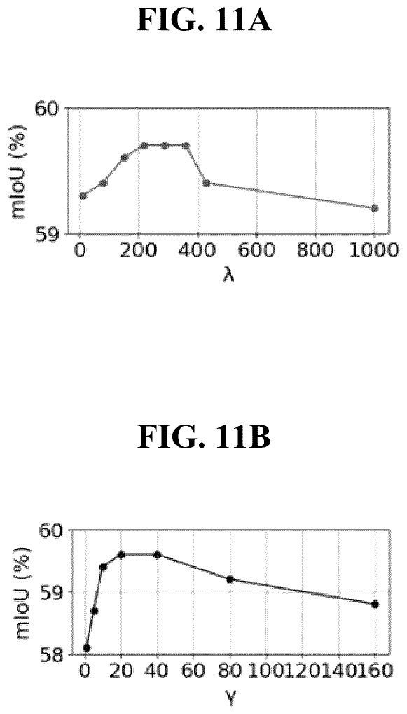

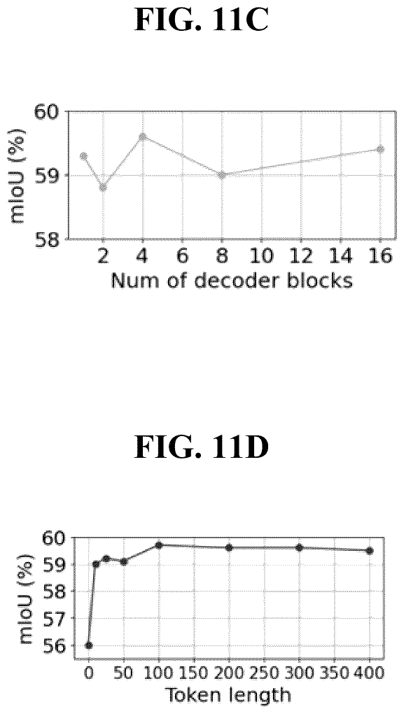

FIGS. 11A to 11D are graph diagrams illustrating an example of sensitivity of a hyperparameter, FIG. 11A is for lambda (λ) which is a hyperparameter for total loss, FIG. 11B is for gamma (γ) which is a hyperparameter for loss of the first fusion processor 110, FIG. 11C is the number of convnext blocks, and FIG. 11D is the length of the learnable token 90.

As shown in FIGS. 11A to 11D, the above-described image segmentation apparatus 10 shows robust performance for most hyperparameters including loss balance between the plurality of fusion processors 110 and 120, decoder depth, and the like.

The above-described image segmentation apparatus 10 may overcome the limitations of existing image segmentation technologies to derive more precise and high-accuracy segmentation results. For example, the image segmentation apparatus 10 according to an embodiment may integrate the region information from the initial encoder stage to maintain details at the pixel level, and obtain a more accurate image segmentation result based on the details. In particular, since local information is essential to identify boundaries or detailed features of individual objects in image segmentation, the initial integrated reflection thereof may greatly improve individual or overall performance of image segmentation.

In addition, the image segmentation apparatus 10 may be implemented using a convolutional neural network-based decoder as well as a transformer-based decoder, and shows excellent performance even in an embodiment using such a convolutional neural network-based decoder. When such a convolutional neural network-based decoder is employed, the image segmentation apparatus 10 may efficiently process local information by taking advantage of the structural advantages of the convolutional neural network, thereby more accurately segmenting detail(s) that play an important role in the image segmentation operation, such as the boundary of an object. Accordingly, the image segmentation apparatus 10 may exhibit improved performance compared to the conventional case, with higher versatility applicable to various application fields.

In addition, the image segmentation apparatus 10 may maximize performance without changing additional data or a complex model structure. For example, the image segmentation apparatus 10 may improve the accuracy of image segmentation up to about 4.8% compared to the known techniques. The image segmentation apparatus 10 records the highest level of performance even in various benchmarks such as NYUDv2, SUN RGB-D, and DeLiVER, which indicates that the image segmentation apparatus 10 may be effectively and flexibly applied even when various data sets having different characteristics are given in various environments.

As described above, the image segmentation apparatus 10 may be applied to various modalities. For example, the image segmentation apparatus 10 shows consistent performance improvement in various input modalities such as RGB, RGB-D, and Depth-only. In other words, the image segmentation apparatus 10 may be flexible with respect to various types of input data. This shows that the image segmentation apparatus 10 may be easily employed and utilized in various different application fields (e.g., magnetic resonance imaging apparatuses, etc.).

The above-described image segmentation apparatus 10 may be implemented by using a specially designed apparatus to perform processing such as the above-described operation or control, or may be implemented by using one or two or more information processing apparatuses alone or in combination. Here, the information processing device may be, for example, a desktop computer, a laptop computer, a hardware device for a server, a smart phone, a tablet PC, a smart watch, a smart tag, a smart band, a HMD (Head Mounted Display) device, a portable game machine, a navigation device, a digital photographing device (camera, etc.), a video photographing device (camcorder or action cam, etc.), a scanner device, a printer device, a three-dimensional printer device, a remote control device, a digital television, a set top box, a digital media player device, a media streaming device, a DVD reproducing device, a sound reproducing device (artificial intelligence speaker, etc.), a home appliance (e.g., a refrigerator, a fan, an air conditioner, a washing machine, etc.), a medical device (e.g., a CT (Computed Tomography), an MRI (Magnetic Resonance Imaging) device, an X-ray imaging device, or a PET (Positron Emission Tomography)), manned or unmanned mobile objects (e.g. example, vehicles, mobile robots, wireless model cars, or robotic vacuum cleaners), manned or unmanned aerial vehicles (for example, airplanes, helicopters, drones, model airplanes, or model helicopters), household, industrial, or military robots, industrial or military machines, or traffic controllers, but is not limited thereto. A designer, a user, or the like may employ at least one of various devices for processing and controlling information in addition to the above-described information processing device according to a situation or condition by considering it as the above-described image segmentation apparatus 10.

The above-described image segmentation apparatus 10 may perform mutual communication with another external device (e.g., a desktop computer, server hardware, a vehicle, a medical device, or the like) based on a wired communication network, a wireless communication network, or a combination thereof by using a predetermined communication module (e.g., a LAN card, a wireless communication chip, or the like). In this case, the image segmentation apparatus 10 may transmit the obtained image segmentation result to another wired/wireless device, in real time, or at a predefined time point, so that the segmentation image may be used by another device. Here, the wireless communication network may include a short-range communication network or a long-range communication network according to an embodiment, and the short-range communication network may include a network implemented based on a communication technology such as Wi-Fi, Wi-Fi Direct, Bluetooth, Bluetooth low energy, Zigbee communication, CAN communication, UWB (Ultra-WideBand) communication, RFID (Radio-Frequency IDentification), and/or NFC (Near Field Communication), and the long-range communication network may include a mobile communication network implemented based on a mobile communication standard such as 3GPP, 3GPP2, Wibro, or Wimax.

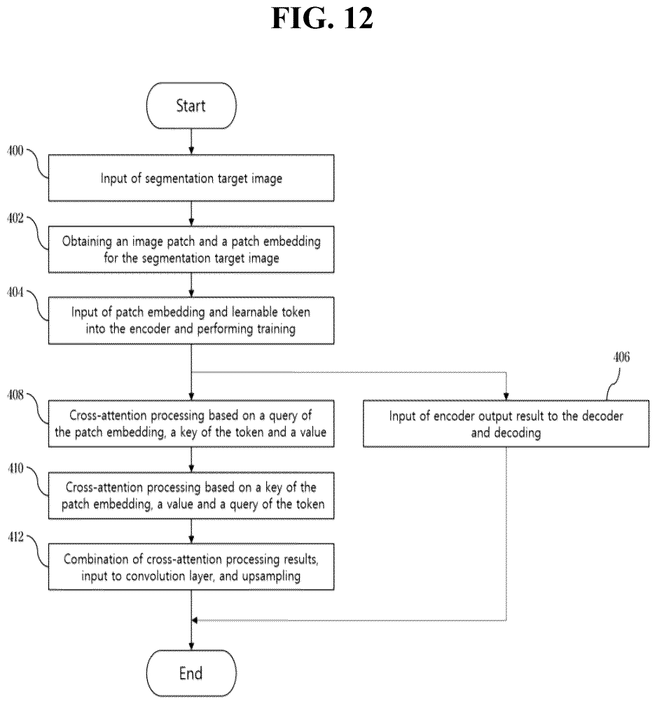

Hereinafter, an embodiment of an image segmentation method will be described with reference to FIG. 12.

FIG. 12 is a flowchart of an image segmentation method according to an embodiment.

Referring to FIG. 12, at least one segmentation target image is input according to a user's manipulation or a predefined setting (400).

An image patch for the segmentation target image is obtained, and a projection is performed on each image patch to obtain patch embedding corresponding to the image patch (402).

A patch embedding and learnable token are input to the encoder (404). Here, the encoder may include, for example, a transformer encoder, but may also include a vision transformer encoder. In the encoder, a connection between patch embedding for a region including all or part of a specific target and a learnable token related to the corresponding region may be performed. The encoder may include a plurality of layers, and whenever passing through each layer, connectivity between a learnable token and regional information, for example, a specific object in the region, may be strengthened. If necessary, the sequence embedding finally output from the encoder may be a result from which a learnable token is removed.

The output result of the encoder, for example, the sequence embedding from which the learnable token is removed, may be input to the decoder (406). The decoder may obtain a prediction result for image segmentation by upsampling based on an output result of the encoder (i.e., image embedding). The decoder may be provided by employing at least one of various types of decoders, and may be implemented using, for example, a vision transformer-based decoder or a convolutional neural network-based decoder. The input to the decoder may be performed during training or may be performed during prediction. At the time of prediction, steps 408 to 412 to be described later may not be performed.

The above-described process may be performed by the first fusion processor.

Meanwhile, the query embedding vector of the patch embedding obtained by the encoder, the key embedding vector of the learnable token, and the value embedding vector may be obtained, and patch-token cross-attention processing may be performed (408).

In addition, a key embedding vector and a value embedding vector of the patch embedding obtained as a result of the patch-token cross-attention processing, and a query embedding vector for the learnable token may be obtained, and token-patch cross-attention processing may be further performed (410).

The result sequence according to the patch-token cross-attention processing and the result sequence according to the token-patch cross-attention processing may be combined with each other, input to the convolutional layer, and sequentially upsampled (412).

The above-described processes 408 to 412 may be performed by the second fusion processor.

Accordingly, the relationship between the learnable token and the patch embedding for the image including the local information and the global information may be properly trained, and accordingly, the image may be more accurately segmented.

The image segmentation method according to the above-described embodiment may be implemented in the form of a program that may be driven by a computer device. The program may include an instruction, a library, a data file, and/or a data structure alone or in combination, and may be designed and manufactured using machine language code or high-level language code. The program may be specially designed to implement the above-described method, or may be implemented using various functions or definitions that are known and used by those skilled in the art in the field of computer software. In addition, the computer device may be implemented by including a processor or a memory that enables the function of a program to be realized, and may further include a communication device as necessary. A program for implementing the above-described image segmentation method may be recorded in a recording medium readable by a device such as a computer. The computer-readable recording medium may include, for example, at least one type of physical storage medium capable of temporarily or non-temporarily storing one or more programs executed according to a call of a device such as a computer, such as a semiconductor storage medium such as a ROM, a RAM, a SD card, or a flash memory (e.g., a solid state drive (SSD)), a magnetic disk storage medium such as a hard disk or a floppy disk, an optical recording medium such as a compact disk or a DVD, or a magneto-optical recording medium such as a floptical disk.

Although various embodiments of the image segmentation apparatus and the image segmentation method have been described above, the apparatus or the method is not limited to the above-described embodiments. Other various devices or methods that may be modified and modified based on the above-described embodiment by those of ordinary skill in the art may also be an embodiment of the above-described image segmentation apparatus or image segmentation method. For example, even if the described method(s) are performed in a different order than that described, and/or if the described component(s) of the system, structure, apparatus, circuit, etc. are combined, connected, or combined in a different form than that described, or substituted or substituted by another component or equivalent, etc., the above-described image segmentation apparatus and/or image segmentation method may be an embodiment of the above-described image segmentation apparatus and/or image segmentation method.

It will be understood by those skilled in the art to which the embodiments of the present invention pertain that various modifications can be made without departing from the essential characteristics of the present disclosure. Accordingly, the disclosed methods should be considered in an illustrative rather than a limiting sense. The scope of the present invention is defined by the claims, not by the detailed description, and all variations equivalent thereto are to be construed as being included within the scope of the present invention.

What is claimed is:

1. An image segmentation apparatus comprising:
a first fusion processor configured to obtain a patch embedding corresponding to an segmentation target image, obtain a learnable token related to a target in the segmentation target image, and perform encoding using an encoder based on the patch embedding and the learnable token and
a second fusion processor configured to obtain information on the patch embedding, obtain information on the learnable token, and perform decoding based on the information on the learnable token and the patch embedding.

2. The image segmentation apparatus of claim 1,
wherein the first fusion processor removes a learnable token from a sequence embedding output from the encoder, and performs decoding using a decoder based on the sequence embedding from which the learnable token is removed, and
wherein the decoder includes at least one of a vision transformer-based decoder and a convolutional neural network-based decoder.

3. The image segmentation apparatus of claim 2,
wherein the information on the patch embedding comprises query embedding for the patch embedding obtained by the first fusion processor, and
wherein the second fusion processor performs patch-token cross-attention processing based on query embedding for the patch embedding, key embedding obtained from the learnable token, and value embedding obtained from the learnable token, and token-patch cross-attention processing based on key embedding and value embedding for the patch embedding obtained by performing the patch-token cross-attention processing and query embedding obtained from the learnable token.

4. The image segmentation apparatus of claim 3,
wherein the second fusion processor combines a result sequence by the patch-token cross-attention processing and a result sequence by the token-patch cross-attention processing, inputs a result of combining the result sequence to a convolutional neural network, and performs an upsampling processing on an output of the convolutional neural network.

5. An image segmentation method comprising:
obtaining a patch embedding corresponding to an segmentation target image;
obtaining a learnable token related to a target in the segmentation target image;
performing encoding using an encoder based on the patch embedding and the learnable token; and
obtaining information on the patch embedding, obtaining information on the learnable token, and performing decoding based on information on the learnable token and the patch embedding.

6. The image segmentation method of claim 5, further comprising:
removing a learnable token from a sequence embedding output from the encoder; and
performing decoding using a decoder based on the sequence embedding from which the learnable token is removed,
wherein the decoder includes at least one of a vision transformer-based decoder and a convolutional neural network-based decoder.

7. The image segmentation method of claim 6,
wherein the obtaining information on the patch embedding, obtaining information on the learnable token, and performing decoding based on the patch embedding and information on the learnable token comprises at least one of:
performing patch-token cross-attention processing based on query embedding for the patch embedding obtained by the encoder, key embedding obtained from the learnable token, and value embedding obtained from the learnable token; and
performing token-patch cross-attention processing based on key embedding and value embedding for the patch embedding obtained by performing the patch-token cross-attention processing and query embedding obtained from the learnable token.

8. The image segmentation method of claim 7,
wherein the obtaining information on the patch embedding, obtaining information on the learnable token, and performing decoding based on the patch embedding and information on the learnable token further comprises:
combining a result sequence by the patch-token cross-attention processing and a result sequence by the token-patch cross-attention processing, inputs a result of combining the result sequence to a convolutional neural network, and performs an upsampling processing on an output of the convolutional neural network.
